(19) United States
(12) Patent Application Publication
(10) Pub. No.: US 2026/0088756 A1
(43) Pub. Date: Mar. 26, 2026

(54) PVT MODULE, METHOD FOR MANUFACTURING A PVT MODULE, PVT ARRANGEMENT, AND THERMAL ABSORBER

(71) Applicant: MUHR UND BENDER KG, Attendorn (DE)

(72) Inventors: Thomas MUHR, Attendorn (DE); Stefan BUCHKREMER, Reichshof (DE); Elisabeth DANGER, Paderborn (DE); Björn SCHOLEMANN, Drolshagen (DE)

(73) Assignee: MUHR UND BENDER KG, Attendorn (DE)

(21) Appl. No.: 19/333,862

(22) Filed: Sep. 19, 2025

(30) Foreign Application Priority Data
Sep. 20, 2024 (DE) 102024127309.7

(51) Int. Cl. H02S 40/44; F24S 10/75; F24S 80/30

(52) U.S. Cl. CPC H02S 40/44; F24S 10/753; F24S 80/30

(57) ABSTRACT

A PVT module having a photovoltaic cell and a thermal absorber includes a thermal absorber having a composite plate structure comprising overlapping plates that are connected to one another by material bond in coupling surfaces. The plates are separated from one another outside the coupling surfaces, wherein channels are formed between the plates outside the coupling surfaces by a forming process on at least one of the plates, wherein the channels form a channel system integrated in the composite plate structure. A method for manufacturing a PVT module and PVT arrangement with at least two PVT modules are further disclosed.

### CROSS-REFERENCE TO RELATED APPLICATIONS

This application claims priority to German Patent Application No. DE 102024127309.7 filed Sep. 20, 2024, the disclosure of which is hereby incorporated in its entirety by reference herein.

### TECHNICAL FIELD

The application relates to a photovoltaic thermal module (PVT module) with a photovoltaic cell and a thermal absorber, a method for manufacturing a PVT module, a PVT arrangement with at least two PVT modules, and to a thermal absorber.

### BACKGROUND

A PVT module, is used for combined electricity and heat generation. For example, it can be used to provide low-temperature heat for heat pumps to generate hot water and heating energy and to cool buildings, and can simultaneously cover at least part of the electricity requirements of the heat pump and/or a household.

DE 20 2016 003 756 U1 discloses a combined photovoltaic thermal module comprising a photovoltaic module which is provided on the side facing away from the sun with a heat exchanger structure through which a liquid or gaseous heat transfer medium flows, the heat exchanger structure being in heat-conducting contact with the photovoltaic module in one part and running through the ambient air as a heat exchanger between air and heat transfer medium in another part without direct contact with the photovoltaic module.

U.S. Pat. No. 11,870,392 B2 discloses a modular, solar energy system comprising one or more modular solar panels. The solar panels include a pair of general planar, plates that are secured together to form a narrow channel therebetween for the circulation of a liquid. The solar panels have inlet and outlet fluid lines in fluid communication via manifolds with a cold fluid supply line and a warm fluid return line, respectively. The plates are preferably constructed of aluminum and one plate has a photovoltaic cell matrix affixed thereto to face the sun.

DE 10 2015 105 708 A1 discloses a structural element, comprising a profiled front side, a rear side, at least one fluid line, wherein the structural element is adapted to provide a fluid disposed in the fluid line to be heated upon irradiation of the front side by sunlight.

A disadvantage is a complex and expensive design of a heat exchanger structure with a large number of components, which result in numerous heat transfers that reduce thermal efficiency and require complex assembly. Against this background, scaling up production technology to high quantities only seems possible with considerable effort.

### SUMMARY

In one or more embodiments, a PVT module with a photovoltaic cell and a thermal absorber, in which the thermal absorber effectively extracts thermal energy from the ambient air and/or from the heat flow of the photovoltaic cell, is integrated in a single component.

The PVT module or photovoltaic thermal module has a photovoltaic cell and a thermal absorber, wherein the thermal absorber has a composite plate structure consisting of overlapping plates that are materially bonded to each other in coupling surfaces. The plates are separated from each other outside the coupling surfaces and channels are formed between the plates outside the coupling surfaces by a forming process on at least one of the plates, the channels forming a channel system integrated in the composite plate structure. The composite plate structure has base sections in thermally conductive contact with the photovoltaic cell as well as plateau sections and flank sections arranged at a distance from the photovoltaic cell, wherein the channels for conducting a liquid or gaseous heat transfer medium are arranged in at least one of the base sections, the plateau sections and the flank sections.

The channels can be arranged exclusively in the base sections and in the plateau sections or exclusively in the base sections and in the flank sections or exclusively in the base sections and in the flank sections. Furthermore, the channels can be arranged in the base sections and in the plateau sections and in the flank sections.

The use of the plural form for the base sections and the plateau sections and the flank sections is not to be understood as being limited to a respective plurality. Instead, only one base section, plateau section or flank section can be provided. The channels can be provided in only some of the base sections, plateau sections or flank sections. Several channels can run in a single base section, plateau section or flank section. The channels can run from the base sections into the flank sections or from the flank sections into the plateau sections or vice versa.

The one-piece thermal absorber has the advantage of few heat transfers between components and is therefore effective. As there is no full-surface connection between the thermal absorber and the photovoltaic cell, lower thermal stresses occur.

A photovoltaic cell, also known as a solar cell, is an electronic component that converts sunlight directly into electrical energy. This process is known as the photovoltaic effect. The main materials in solar cells consist of semiconductors such as silicon. When sunlight hits the cell, the semiconductor material absorbs photons. These photons excite the electrons in the semiconductor material so that they can move freely. These free electrons generate an electric current when they are passed through an electric field in the cell. Photovoltaic cells are the basic component of solar panels, which can have one or more photovoltaic cells. For the purposes of the application, the PVT module may also have a plurality of photovoltaic cells and the thermal absorber may accordingly be connected to the plurality of photovoltaic cells.

The thermal absorber is a device that transfers thermal energy by conduction from the photovoltaic cell and by convection from the ambient air into a material flow in the channels. A heat-carrying fluid or a cooling medium can be fed through the channel. The plates of the composite plate structure can be joined by soldering, gluing or welding, for example. The plates of the composite plate structure can be bonded using roll-bond technology, for example. The materially bonded plates are held together by atomic or molecular forces and cannot be detached. To provide the composite plate structure, the plates can be processed in the form of strip material, for example, which is unwound from corresponding coils. A release coating can be applied to the belt material, if necessary after cleaning and degreasing, usually only on one of the belts. In roll-bond technology, the belts are joined together by rolling under high pressure using a process known as pressure joining. Optionally, the material can be heated beforehand. The release coating prevents the belts from joining in some areas. The composite plate structures are separated, whereby the separation step can generally take place before the plates are joined. Alternatively, the plates of the composite plate structure can be joined by pressing, wherein the release coating that prevents the plates from being joined can be dispensed with.

The forming process of at least one of the plates to form the channels may be hydroforming, in which a high internal pressure is introduced through an opening between the plates by forcing a fluid, such as compressed air, water or oil, into the opening under pressure. The unconnected areas of one or both plates are thus widened to form a channel.

According to an embodiment, a surface of the photovoltaic cell may be divided into a first partial area in thermally conductive contact with the base sections and a second partial area, wherein a ratio of the first partial area to the second partial area may in principle be between 99/1 and 1/99, with ratios between 0.1 and 10 appearing reasonable and in particular between 0.5 and 2. According to a further embodiment, a mass flow of the liquid or gaseous heat transfer medium through the base sections to a mass flow of the liquid or gaseous heat transfer medium through the plateau sections and/or through the flank sections can be in a ratio between 99/1 and 1/99, whereby ratios of the volume flows between 0.1 and 10 appear reasonable and are in particular between 0.5 and 2. The skilled person will recognize that the same applies to corresponding volume flows and their ratios, as the mass flow of the liquid or gaseous heat transfer medium is linked to the volume flow via its density.

Viewed in cross-section, the channels can extend over a smaller width than the respective extension of the associated base section, plateau section or flank section.

The composite plate structure can take the form of a corrugated sheet or a trapezoidal sheet, with the plateau sections being connected to the base sections via the flank sections, so that the plateau sections form a ventilation channel with the flank sections and the photovoltaic cell. In principle, the flank sections can also be arranged perpendicular to the plateau sections and the base sections or form an acute angle with them. Apertures through the composite plate structure can be provided as ventilation openings in the flank sections and the plateau sections.

The base sections and the plateau sections can be designed as a rounding of a bending edge between two flank sections. In this case, at least one of the base sections and the plateau sections can have a near infinitesimally small extension, so that two neighboring flank sections are directly connected to each other via the bending edge. The composite plate structure can thus take the form of a folded sheet.

According to a further embodiment, the flank sections and/or the plateau sections can be free towards an environment in order to allow the flank sections and the plateau sections to be flowed around by the ambient air. This means that no other component is connected to the flank sections or the plateau sections.

According to a further embodiment, the channels in the base sections may be formed by deformation of only one of the plates, with the plate facing away from the photovoltaic cell being deformed. As a result, the undeformed plate facing the photovoltaic cell is in optimum contact with the surface of the photovoltaic cell. In principle, the channels can be deformed on both sides, on one side or in a locally varying combination of one and both sides.

The plateau sections can be arranged at a distance between 15 mm and 100 mm from the photovoltaic cell. Basically, the minimum distance is given by the height of the channel plus the thickness of the plate. A maximum is given by the distance between the back of the PV module and the roof surface of the building. The sheet thickness can be between 0.5 mm and 4.5 mm. The plates are made of metal, for example, in particular aluminum or an aluminum alloy.

The channels can be connected at a first end to at least one inlet and at a second end to at least one outlet, whereby the inlet and/or the outlet can be provided in the form of a collecting channel. The collecting channel can be formed by deforming at least one of the plates by means of hydroforming.

According to a further embodiment, the thermal absorber can have a surface enlargement, which increases the absorption of thermal energy by convection from the ambient air. The surface enlargement can be provided in the form of ribs attached to the composite plate structure, which are attached in particular along the channels, for example by soldering, gluing, welding, clamping, screwing or riveting. Accordingly, the ribs can be attached to at least one of the base sections, the plateau sections and the flank sections. Alternatively, the surface enlargement can take the form of deformation of the composite plate structure itself, particularly in the area of the plateau sections and/or the flank sections. The deformation can be a wave shape or a zig-zag shape, for example. This variant of surface enlargement also advantageously allows a larger number of channels to be arranged over the same surface of the photovoltaic cell.

A further object of the application relates to a thermal absorber with a composite plate structure comprising overlapping plates connected to one another in coupling surfaces by material bond, wherein the plates are separated from one another outside the coupling surfaces, wherein channels are formed between the plates outside the coupling surfaces by a forming process on at least one of the plates. The composite plate structure is shaped in such a way that base sections are formed in a contact plane and plateau sections and flank sections are arranged at a distance from the contact plane, with the channels for conducting a liquid or gaseous heat transfer medium being arranged in the base sections and/or in the plateau sections and/or in the flank sections. The thermal absorber is intended for connection to a surface of a photovoltaic cell facing away from the sun and forms the PVT module described above. The thermal absorber is connected to the surface of the photovoltaic cell facing away from the sun, for example by laminating or gluing. Mechanical connections such as clamps, screws, rivets etc. are also conceivable. All the features and embodiments described above with reference to the PVT module are applicable and transferable to the thermal absorber.

A further object of the application relates to a method for producing a PVT module or thermal absorber, wherein a ratio of the first partial area to the second partial area is selected depending of a locally or regionally expectable solar radiation output and/or locally or regionally expectable ambient temperatures. Alternatively or additionally, a ratio of a mass flow of the liquid or gaseous heat transfer medium through the channels in the base sections to the mass flow through the channels in the plateau sections is selected as a function of the solar radiation output that can be expected locally or regionally and/or the ambient temperatures that can be expected locally or regionally. The mass flows can be adjusted, for example, by the number and/or flow cross-section of the channels.

A further object of the application relates to a PVT arrangement with at least two PVT modules as described above, wherein the channels of each PVT module connect an inlet to an outlet, wherein the inlets of the PVT modules are connected to a supply line and that the outlets of the PVT modules are connected to a return line. The channels of the respective PVT modules in a direction of flow in the supply line have a decreasing hydraulic resistance. The decreasing hydraulic resistance of the PVT modules can be effected by differences in the number and/or flow cross-section of the respective channels.

This allows hydraulic balancing of the PVT modules supplied in parallel by the supply line to be adjusted by the design of the channels, which can be easily varied during production using roll bonding and hydroforming, for example, without increasing production costs. The use of valves for hydraulic balancing can be advantageously omitted. The hydraulic and thermal advantages of the parallel connection, such as low pressure loss and homogeneous temperature distribution, can be achieved with the technical installation advantages of a series connection.

According to an embodiment, the supply line and/or the return line can be formed in sections in the form of collecting ducts in the composite plate structure of the respective PVT modules, with the collecting ducts being connected between the PVT modules via pipes and/or hoses. The collecting channels can be formed by hydroforming, for example.

The connections of the collecting ducts in the PVT modules for connecting the pipes can be designed in such a way that the PVT modules can only be connected to each other in the order of their increasing hydraulic resistance, so that incorrect assembly is avoided. Furthermore, the connections of the collector ducts forming the supply line can differ from the connections of the collector ducts forming the return line in terms of their type, shape and/or arrangement in order to prevent confusion between the supply and return lines.

The invention is explained further below with reference to the accompanying drawings. The explanations relate equally to the PVT module, the thermal absorber, the process for manufacturing a PVT module and the PVT arrangement. In the Figures

### BRIEF DESCRIPTION OF THE DRAWINGS

FIG. 1 shows a partial schematic perspective view of an embodiment of a PVT module;

FIG. 2 is a perspective view of a thermal absorber for a further embodiment of a PVT module;

FIG. 3 shows a schematic representation of a PVT arrangement;

FIG. 4 is a schematic representation of another embodiment of a PVT arrangement;

FIG. 5 shows a further embodiment of a thermal absorber for a PVT module in a perspective view;

FIG. 6 shows another embodiment of a PVT module in a schematic partial perspective view; and

FIG. 7 shows another embodiment of a PVT module in a schematic partial perspective view.

### DETAILED DESCRIPTION

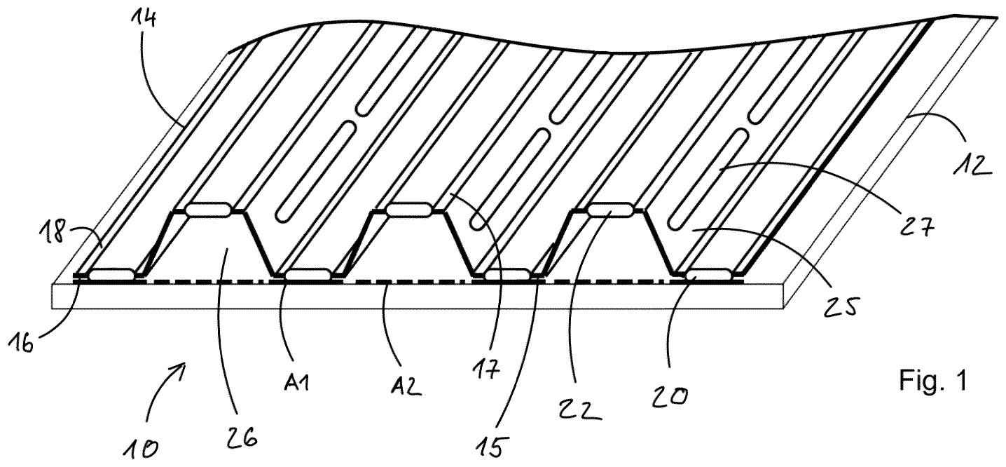

FIG. 1 shows a part of an embodiment of a PVT module 10. The PVT module 10 has a photovoltaic cell 12 and a thermal absorber 14. The thermal absorber 14 has a composite plate structure comprising overlapping plates 16, 18 which are materially bonded to one another in coupling surfaces, the plates 16, 18 being separated from one another outside the coupling surfaces. Channels 20, 22 are formed between the plates 16, 18 outside the coupling surfaces by deformation of at least one of the plates 16, 18 by means of hydroforming. The composite plate structure has base sections 15 in thermally conductive contact with a side of the photovoltaic cell 12 facing away from the sun and plateau sections 17 arranged at a distance from the photovoltaic cell 12, the channels 20, 22 for conducting a liquid or gaseous heat transfer medium (not shown) being arranged in the base sections 15 and in the plateau sections 17. In the illustrated embodiment example, a first channel 20 runs along each base section 15 and a second channel 22 runs along each plateau section 15. In the exemplary embodiment, no channel runs through flank sections 25. In general, the channels 20, 22 for conducting the liquid or gaseous heat transfer medium are arranged in the base sections 15 and/or in the plateau sections 17 and/or in the flank sections 25.

In the exemplary embodiment, the composite plate structure has the shape of a trapezoidal sheet, although a corrugated sheet shape is also conceivable. The plateau sections 17 are connected to the base sections 15 via the flank sections 25, so that the plateau sections 17 each form a ventilation channel 26 with two flank sections 25 and the photovoltaic cell 12. In the flank sections 25, apertures 27 through the composite plate structure are provided as ventilation openings.

A surface of the side of the photovoltaic cell 12 facing away from the sun is divided into a first partial area A1 in thermally conductive contact with the base sections 15 and a second partial area A2. The first partial area A1 consists of strips that alternate with strips of the second partial area A2. A ratio of the first partial area A1 to the second partial area A2 is approximately 0.66 in the exemplary embodiment shown.

The channels 20 in the base sections 15 may be formed by deformation of only one of the plates 16, 18, with the plate 16 facing away from the photovoltaic cell 12 being deformed. The plates 16, 18 of the composite plate structure are bonded in the coupling surfaces by roll bonding, for example. After roll bonding, the channels 20, 22 are formed by deforming at least one of the plates 16, 18 by means of hydroforming and the composite plate structure, which is flat after roll bonding, is deformed into the trapezoidal shape, for example by a pressing process. Both possible sequences of hydroforming and pressing are possible. Depending on the amount of deformation or the degree of deformation, large deformations must first be pressed and then hydroformed. Alternatively, internal high-pressure forming can also be used first for smaller forming degrees and then formed by pressing. In addition to the degree of forming, the material thickness and ductility are decisive for the sequence. The more ductile and thicker the material, the more likely it is that the preferred option is to first carry out hydroforming and then form the composite plate structure by pressing. The plateau sections 17 can be between 15 mm and 100 mm away from the photovoltaic cell 12.

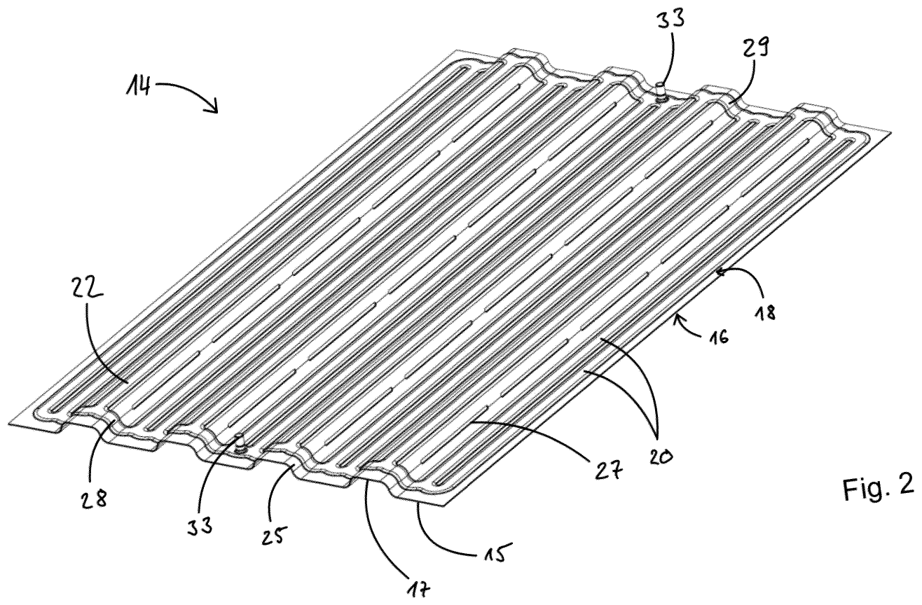

FIG. 2 shows a perspective view of a thermal absorber 14 for a further embodiment of a PVT module 10. The thermal absorber 14 with the composite plate structure with channels 20, 22 has base sections 15 in a contact plane and plateau sections 17 at a distance from the contact plane. In contrast to the previously described exemplary embodiment, two channels 20 for conducting a liquid or gaseous heat transfer medium are formed in each base section 15, while one channel 22 runs in each of the plateau sections 17. The channels 20 in the base sections 15 and the channels 22 in the plateau sections 17 are connected at a first end to an inlet 28 and at a second end to an outlet 29, each of which is in the form of a collecting channel. The collecting channel is also formed by deformation of at least one of the plates 16, 18 by means of hydroforming. The inlet 28 and outlet 29 each have a connector 33 for connection to a supply line or return line not shown. The connectors can be aligned perpendicular to the plane of the composite plate structure, as shown. Alternatively, these can also lie in the plane of the composite plate structure. The degree of deformation is low in the exemplary embodiment shown. The transitions from the plateau sections 17 to the flank sections 25 and from the flank sections 25 to the base sections 15 have a radius that allows deformation of the composite plate structure into the trapezoidal shape after hydroforming of the channels 20, 22, the inlet 28 and the outlet 29.

The partial areas A1 and A2 not shown are arranged analogously to FIG. 1. A ratio of the first partial area A1 to the second partial area A2 is approximately 1 in the exemplary embodiment shown. In the following, exemplary relationships between the area, mass flow and power distributions of the channels 20 in the base sections 15 with direct contact to the photovoltaic cell 12 and the channels 22 in the plateau sections 17 without direct contact to the photovoltaic cell 12 are described. In one design of the PVT module 10 or the thermal absorber 14, the first partial area A1, in which the composite plate structure is in contact with the PV module 12, and the second partial area A2, which is only in contact with the ambient air, could each be 50%. Furthermore, the proportion of a mass flow that is guided through the channels 20 in the base sections 15 could be 70% by a fluidic design of the channels 20, 22. In this case, 30% of the mass flow would flow through the channels 22 in plateau sections 17 that are not directly connected to the photovoltaic cell 12. During the day, with 1,000 W/m2 of normal solar radiation, an inlet temperature of the liquid or gaseous heat transfer medium in the thermal absorber 14 of 20° C. and an ambient temperature of 25° C., approx. 85% of the thermal power gained would be accounted for by the channels 20 in the base sections 15, which would correspond to approx. 33.7 kW per kg/s mass flow if, for example, a 1/1 water-glycol mixture were used. 15% of the power would come from the channels 22 in plateau sections 17, approx. 12.7 kW per kg/s mass flow. At night, the situation would be reversed. With the same area and mass flow distribution of the thermal absorber 14, only 67% of the thermal output would come from the channels 20 in the base sections 15 and 33% from the channels 22 in the plateau sections 17. The specific power per mass flow of the channels 20 in the base sections 15 would drop by 85% from 33.7 to 5.7 kW/(kg/s), while it would only drop by 50% from 12.7 to 6.5 kW/(kg/s) for the channels 22 in the plateau sections 17. The example shows that under conditions of low or negligible solar radiation, the proportion of thermal energy obtained from the ambient air increases disproportionately compared to the case of more intensive radiation. This can be used to ensure the performance of the thermal absorber 14, e.g. for the operation of heat pumps, when solar radiation is low, by specifically designing the area and mass flow components. For latitudes where a lower solar radiation output is to be expected, the area proportion of the second partial area A2 of the channels 22 in the plateau sections 17 would therefore tend to be selected higher.

In a method for manufacturing the PVT module 10 or the thermal absorber 14, a ratio of the first partial area A1 to the second partial area A2 is selected as a function of a solar radiation output that can be expected locally or regionally. Alternatively or additionally, a ratio of the mass flow of the liquid or gaseous heat transfer medium through the channels 20 in the base sections 15 to the mass flow through the channels 22 in the plateau sections 17 is selected as a function of the solar radiation output that can be expected locally or regionally. The mass flows can be adjusted, as in the exemplary embodiment, by a number and/or by a flow cross-section of the channels 20, 22.

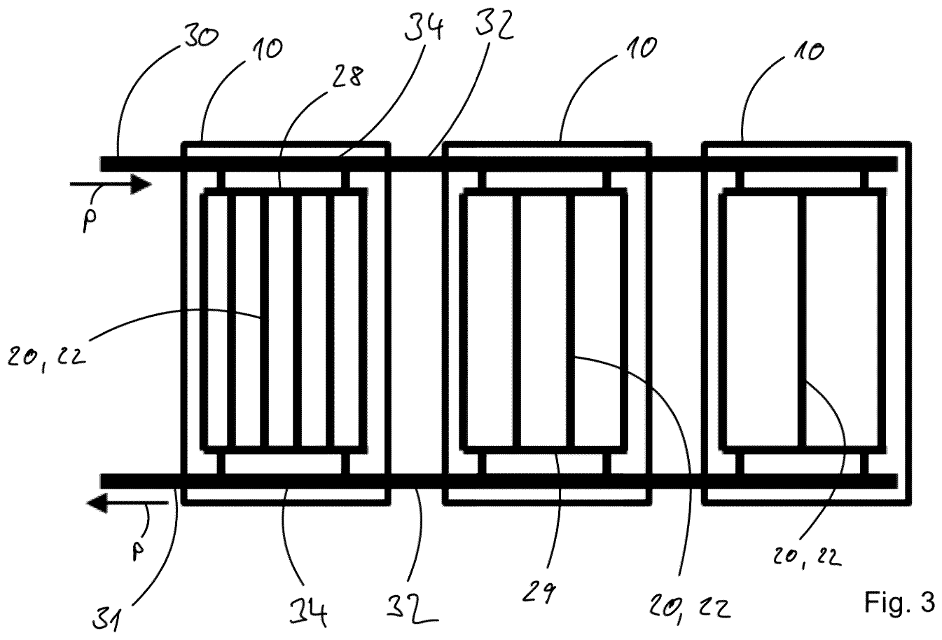

FIG. 3 schematically shows one embodiment of a PVT arrangement. The PVT arrangement has, for example, three PVT modules 10, with the channels 20, 22 of each PVT module 10 connecting an inlet 28 to an outlet 29. The inlets 28 of the PVT modules 10 are connected to a supply line 30 and the outlets 29 to a return line 31. The arrows P represent the direction of flow of the liquid or gaseous heat transfer medium. The channels 20, 22 of the respective PVT modules 10 have a decreasing hydraulic resistance in the direction of the flow in the supply line 30. The decreasing hydraulic resistance of the PVT modules 10 may be formed by differences in a number and/or a flow cross-section of the respective channels 20, 22. The supply line 30 and/or the return line 31 can be formed in sections as collecting ducts 34 in the composite plate structure of the respective PVT modules 10, with the collecting ducts 34 being connected between the PVT modules 10 via pipes 32.

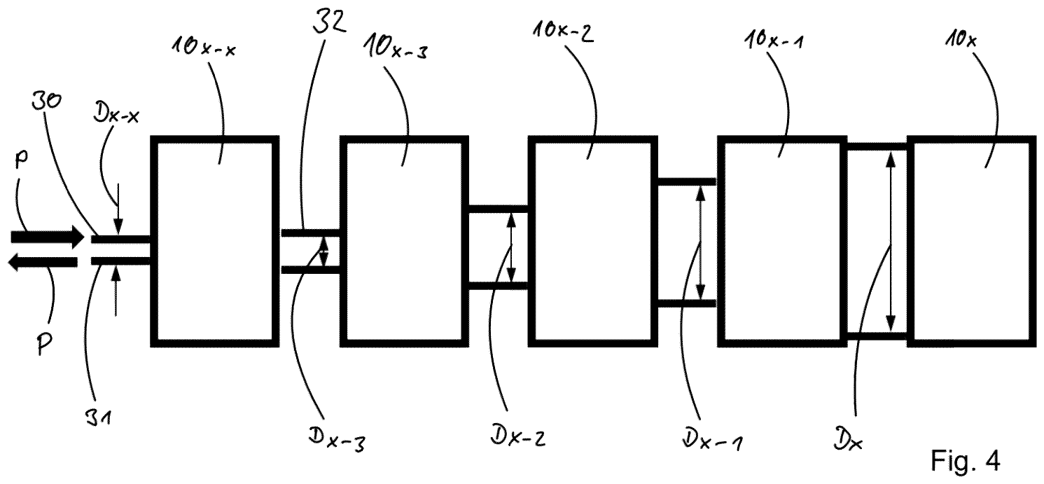

FIG. 4 shows a schematic representation of another embodiment of the PVT arrangement. In the exemplary embodiment, connections of the collecting ducts 34 not shown here, see FIG. 3, in the PVT modules 10 are designed in such a way that the PVT modules 10 can only be connected to each other in the order of their increasing hydraulic resistance. The PVT modules 10 are marked here with an index, whereby the PVT module 10_{X} has the lowest flow resistance, the PVT module 10_{X-1} the next highest, the PVT module 10_{X-2} the next highest and so on. PVT module 10_{X-X} has the highest flow resistance.

In order to ensure assembly in the correct sequence, the distances Dₓ, D_{X-1}, D_{X-2}, D_{X-3} etc. to D_{X-X} between the connections for the pipes 32 from the PVT module 10_{X} to the PVT module 10_{X-X} are designed to decrease in steps in this exemplary embodiment. Different types of connectors can prevent the supply and return lines 30, 31 from being mixed up. Alternatively, the connections can be arranged asymmetrically to each other for this purpose or only the pipes 32 of the supply line 30 have a changing position, while the pipes 32 of the return line 31 are always arranged in the same position or vice versa.

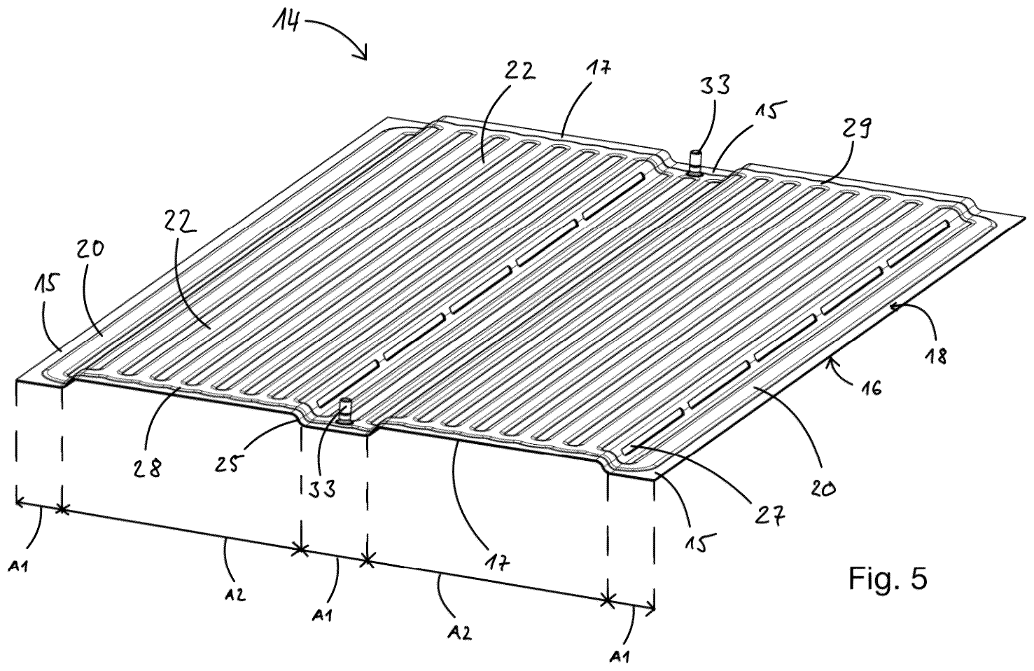

FIG. 5 shows a perspective view of a further embodiment of a thermal absorber 14 for a PVT module 10. The composite plate structure of the thermal absorber has three base sections 15 and two plateau sections 17 with flank sections 25 arranged in between. The channels 20, 22 for conducting the liquid or gaseous heat transfer medium (not shown) are arranged in the base sections 15 and in the plateau section 17, with a plurality of channels 22 extending along each plateau section 17. Apertures 27 are arranged in the flank sections 25. The channels 20, 22 are each connected to the inlet 28 and the outlet 29 in the form of a collecting channel, which can be formed by deformation of at least one of the plates 16, 18 by means of hydroforming. The inlet 28 and the outlet 29 each have a connector 33 aligned perpendicular to the plane of the composite plate structure.

The base sections 15 in the contact plane for the thermally conductive contact with the surface of the photovoltaic cell 12 (not shown) have a comparatively smaller first partial area A1 than in previously described exemplary embodiments. Of the first and second partial areas A1 and A2, only their extent transverse to the channels 20, 22 is indicated. Along the channels 20, 22, the partial areas A1 and A2 extend over the entire composite plate structure. The ratio of the first partial area A1 to the second partial area A2 is in the order of A1/A2=30/70. The ratio of the mass flow of the liquid or gaseous heat transfer medium through the channels 20 in the base sections 15 to the mass flow through the channels 22 in the plateau sections 17 or flank sections 25 is also approximately 30/70.

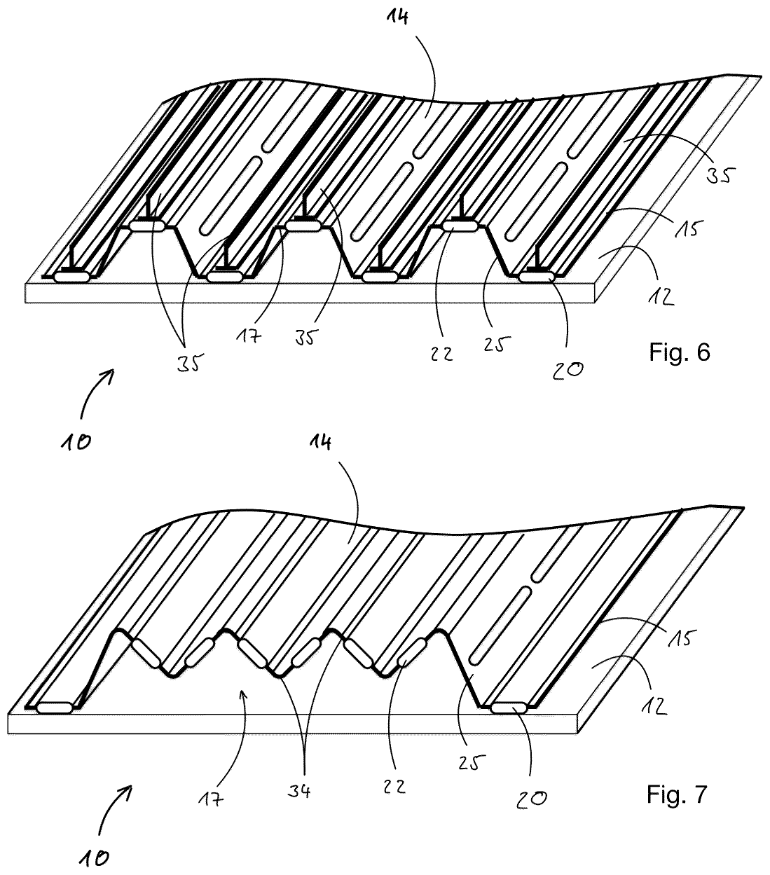

FIG. 6 schematically shows another embodiment of the PVT module 10. The thermal absorber 14 has an increased surface area, which increases the absorption of thermal energy by convection from the ambient air. The surface enlargement consists of ribs 35 attached to the composite plate structure, which are attached in particular along the channels 20, 22. The ribs 35 are attached to the base sections 15 and to the plateau sections 17, but may also be attached to the flank sections 25.

FIG. 7 shows a schematic representation of another embodiment of the PVT module 10. The thermal absorber 14 has a surface enlargement in the form of a deformation 34 of the composite plate structure itself, here in the region of a single plateau section 17, although such a deformation 34 would also be conceivable in the region of the flank sections 25. The deformation 34 has a wave or zig-zag shape. As a result, a larger number of channels 22 can be arranged over the partial area A2 in which the base sections 15 are not connected to the surface of the photovoltaic cell 12. As a result, the ratio of the mass flow of the liquid or gaseous heat transfer medium through the channels 20 in the base sections 15 to the mass flow through the channels 22 in the plateau sections 17 or flank sections 25 can be additionally influenced without changing the ratio of the first partial area A1 to the second partial area A2.

What is claimed is:

1. A PVT module having a photovoltaic cell and a thermal absorber comprising:
a thermal absorber having a composite plate structure comprising overlapping plates that are connected to one another by material bond in coupling surfaces,
the plates being separated from one another outside the coupling surfaces, wherein channels are formed between the plates outside the coupling surfaces by a forming process on at least one of the plates, wherein the channels form a channel system integrated in the composite plate structure,
wherein the composite plate structure has base sections in thermally conductive contact with the photovoltaic cell and plateau sections and flank sections arranged at a distance from the photovoltaic cell,
wherein the channels for conducting a liquid or gaseous heat transfer medium are arranged in at least one of the base sections, the plateau sections and the flank sections.

2. The PVT module according to claim 1, wherein a surface of the photovoltaic cell is divided into a first partial area in thermally conductive contact with the base sections and a second partial area, a ratio of the first partial area to the second partial area being between 0.1 and 10 and in particular between 0.5 and 2.

3. The PVT module according to claim 1, wherein the channels, viewed in cross-section, extend over a smaller width than the respective extent of the associated base section, plateau section or flank section.

4. The PVT module according to claim 1, wherein the channels are arranged only in the base sections and in the plateau sections or only in the base sections and in the flank sections.

5. The PVT module according to claim 1, wherein the composite plate structure has the form of a corrugated sheet or a trapezoidal sheet.

6. The PVT module according to claim 1, wherein at least one of the base sections and the plateau sections are formed as a rounding of a bending edge between two flank sections.

7. The PVT module according to claim 1, wherein at least one of the flank sections and the plateau sections is free towards an environment.

8. The PVT module according to claim 1, wherein the plateau sections are connected to the base sections via the flank sections, the plateau sections forming a ventilation channel with the flank sections and the photovoltaic cell.

9. The PVT module according to claim 8, wherein apertures in the composite plate structure are provided as ventilation openings in at least one of the flank sections and the plateau sections.

10. The PVT module according to claim 1, wherein the channels in the base sections are formed by the forming process on only one of the plates, the plate being the one facing away from the photovoltaic cell.

11. The PVT module according to claim 1, wherein the plateau sections are at a distance between 15 mm and 100 mm from the photovoltaic cell.

12. The PVT module according to claim 1, wherein the channels are connected at a first end to at least one inlet and at a second end to at least one outlet.

13. The PVT module according to claim 12, wherein at least one of the inlet and the outlet have a collecting channel, the collecting channel being formed by the forming process on at least one of the plates.

14. A method for producing a PVT module according to claim 2, wherein a ratio of the first partial area to the second partial area is selected depending of a solar radiation output to be expected locally or regionally and/or depending of ambient temperatures to be expected locally or regionally.

15. A PVT arrangement having at least two PVT modules according to claim 1, wherein the channels of each PVT module connect an inlet to an outlet, wherein the inlets of the PVT modules are connected to a supply line and that the outlets of the PVT modules are connected to a return line, wherein the channels of the respective PVT modules have a decreasing hydraulic resistance in a direction of flow in the supply line.

16. The PVT arrangement according to claim 15, wherein the decreasing hydraulic resistance of the PVT modules is achieved by differences in at least one of a number and a flow cross-section of the respective channels.

17. The PVT arrangement according to claim 15, wherein at least one of the supply line and the return line are designed in sections as collecting ducts in the composite plate structure of the respective PVT modules, the collecting ducts being connected between the PVT modules via pipes and/or hoses.

18. The PVT arrangement according to claim 17, wherein connections of the collecting ducts in the PVT modules for connecting the pipes and/or hoses are designed in such a way that the PVT modules can only be connected to one another in the order of their increasing hydraulic resistance.

19. The PVT arrangement according to claim 18, wherein the connections of the collecting ducts forming the supply line differ from the connections of the collecting ducts forming the return line with regard to at least one of their type, shape and arrangement.

20. A thermal absorber with a composite plate structure comprising:
overlapping plates connected to one another in coupling surfaces by material bond, wherein the plates are separated from one another outside the coupling surfaces; and
channels formed between the plates outside the coupling surfaces by a forming process on at least one of the plates, wherein the channels form a channel system integrated in the composite plate structure,
wherein the composite plate structure is shaped in such a way that base sections are formed in a contact plane and wherein plateau sections, and flank sections are arranged at a distance from the contact plane, and
wherein the channels for conducting a liquid or gaseous heat transfer medium being arranged in at least one of the base sections, the plateau sections and the flank sections.
